(19) United States
(12) Patent Application Publication
(10) Pub. No.: US 2025/0142439 A1
(43) Pub. Date: May 1, 2025

(54) TERMINAL, RADIO COMMUNICATION SYSTEM AND RADIO COMMUNICATION METHOD

(71) Applicant: NTT DOCOMO, INC., Tokyo (JP)

(72) Inventors: Tianyang Min, Tokyo (JP); Masato Taniguchi, Tokyo (JP); Souki Watanabe, Tokyo (JP)

(73) Assignee: NTT DOCOMO, INC., Tokyo (JP)

(21) Appl. No.: 18/683,665

(22) PCT Filed: Aug. 16, 2022
(86) PCT No.: PCT/JP2022/030952

§ 371 Date: Feb. 14, 2024

(30) Foreign Application Priority Data
Aug. 17, 2021 (JP) 2021-132879

(51) Int. Cl. H04W 36/36; H04W 36/08; H04W 36/30; H04W 76/20

(52) U.S. Cl. CPC H04W 36/362; H04W 36/08; H04W 36/305; H04W 76/20

(57) ABSTRACT

A terminal can control an execution of a conditional handover and an execution of a procedure for an addition/change of a secondary cell, and transmit a radio resource control layer message. When the conditional handover and the procedure for the addition/change are configured simultaneously, or when an execution condition of the conditional handover and an execution condition of the procedure for the addition/change are met simultaneously, the terminal prioritizes either the conditional handover or the procedure for the addition/change according to a state of the message.

### TECHNICAL FIELD

The present disclosure relates to a terminal, a radio communication system, and a radio communication method that support a conditional handover, and a procedure for an addition/change of a secondary cell (a secondary node).

### BACKGROUND ART

The 3rd Generation Partnership Project (3GPP) has prepared a specification for the 5th generation mobile communication system (which may be called 5G, New Radio (NR), or Next Generation (NG)), and is also in the process of specifying the next generation called Beyond 5G, 5G Evolution, or 6G.

For example, in 3GPP Release-17, the expansion of Multi-RAT Dual Connectivity (MR-DC) has been studied (NON-PATENT LITERATURE 1).

Specifically, in order to achieve an addition or a change of a Primary SCell (PSCell) more efficiently, support of a procedure for an addition/change of a conditional secondary cell (a secondary node) in which the procedure is simplified (CPAC: conditional PSCell addition/change) has been studied. According to the conditional PSCell addition/change, a terminal (User Equipment, UE) can define an execution condition for determining whether to add or change a PSCell.

In addition, the simultaneous configuration of a conditional handover (CHO) and CPAC has also been studied (NON-PATENT LITERATURE 2).

### CITATION LIST

### Non-Patent Literature

NON-PATENT LITERATURE 1: “Revised WID on Further Multi-RAT Dual-Connectivity enhancements”, RP-201040, 3GPP TSG RAN Meeting #88e, 3GPP, June 2020
NON-PATENT LITERATURE 2: “Summary of [Post113-e] [234] [eDCCA] CPAC procedures (CATT)”, R2-2103109, 3GPP TSG-RAN WG2 meeting #113bis-e, 3GPP, April 2021

### SUMMARY OF THE INVENTION

However, when CHO and CPAC are configured simultaneously, there is a concern that the UE may not operate properly. For example, an operation to release the connection between the UE and a source master node (MN), or a radio link failure (RLF) report or the like may not be performed normally.

Therefore, the following disclosure has been made in view of such circumstances, and an object of the present disclosure is to provide a terminal, a radio communication system and a radio communication method that can operate normally even when CHO and CPAC are configured simultaneously.

An aspect of the present disclosure is a terminal (UE 200) including: a control unit (control unit 240) that controls an execution of a conditional handover and an execution of a procedure for an addition/change of a secondary cell; and a transmission unit (RRC processing unit 220) that transmits a radio resource control layer message, in which when the conditional handover and the procedure for the addition/change are configured simultaneously, or when an execution condition of the conditional handover and an execution condition of the procedure for the addition/change are met simultaneously, the control unit prioritizes either the conditional handover or the procedure for the addition/change according to a state of the message.

An aspect of the present disclosure is a terminal including: a control unit (control unit 240) that controls an execution of a conditional handover and an execution of a procedure for an addition/change of a secondary cell; and a transmission unit (RRC processing unit 220) that transmits a report relating to at least either a radio link failure or a handover, in which the control unit determines contents of the report according to an execution of the conditional handover or an execution of the procedure for the addition/change.

An aspect of the present disclosure is a radio communication method including: a step of controlling an execution of a conditional handover and an execution of a procedure for an addition/change of a secondary cell; a step of transmitting a radio resource control layer message; and when the conditional handover and the procedure for the addition/change are configured simultaneously, or when an execution condition of the conditional handover and an execution condition of the procedure for the addition/change are met simultaneously, a step of prioritizing either the conditional handover or the procedure for the addition/change according to a state of the message.

An aspect of the present disclosure is a radio communication method including: a step of controlling an execution of a conditional handover and an execution of a procedure for an addition/change of a secondary cell; a step of transmitting a report relating to at least either a radio link failure or a handover; and a step of determining contents of the report according to an execution of the conditional handover or an execution of the procedure for the addition/change.

### BRIEF DESCRIPTION OF THE DRAWINGS

FIG. 1 is an overall schematic diagram of a radio communication system 10.

FIG. 2 is a functional block diagram of an eNB 100A and a gNB 100B.

FIG. 3 is a functional block diagram of UE 200.

FIG. 4 is a diagram illustrating an example of a conventional sequence relating to a change of a PSCell when CHO and CPAC are configured.

FIG. 5 is a diagram illustrating an example of a sequence (part 1) relating to a change of a PSCell when CHO and CPAC are configured.

FIG. 6 is a diagram illustrating an example of a sequence (part 2) relating to a change of a PSCell when CHO and CPAC are configured.

FIG. 7 is a diagram illustrating an example of a sequence relating to a successful handover report.

FIG. 8 is a diagram illustrating an example of a hardware configuration of the eNB 100A, the gNB 100B, and the UE 200.

### DESCRIPTION OF EMBODIMENTS

Embodiments will be described below with reference to the drawings. Note that the same or similar reference numerals have been attached to the same functions and configurations, and the descriptions thereof will be omitted as appropriate.

### (1) Overall Schematic Configuration of Radio Communication System

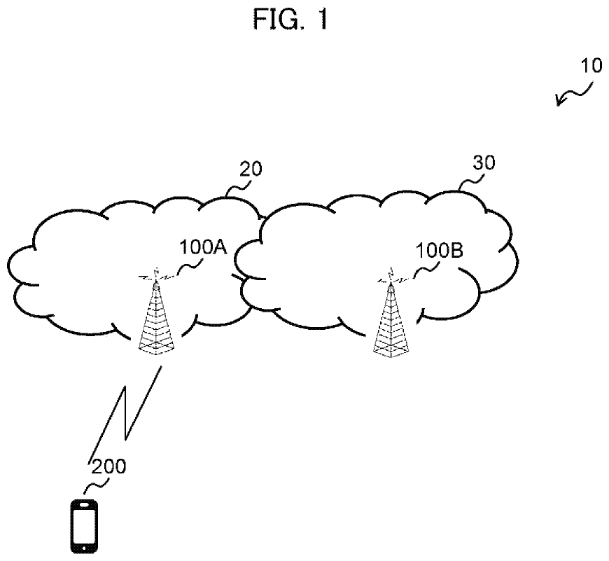

FIG. 1 is an overall schematic diagram of a radio communication system 10 according to the present embodiment. The radio communication system 10 is a radio communication system according to Long Term Evolution (LTE) and 5G New Radio (NR). LTE may be referred to as 4G, or NR may be referred to as 5G. The radio communication system 10 may be a radio communication system according to a system called Beyond 5G, 5G Evolution, or 6G.

LTE and NR may be interpreted as radio access technology (RAT). In the present embodiment, LTE may be referred to as a first radio access technology, and NR may be referred to as a second radio access technology.

The radio communication system 10 includes an Evolved Universal Terrestrial Radio Access Network 20 (hereinafter, E-UTRAN 20), and a Next Generation-Radio Access Network 30 (hereinafter, NG RAN 30). The radio communication system 10 also includes a terminal 200 (hereinafter, UE 200, User Equipment).

The E-UTRAN 20 includes an eNB 100A, which is a radio base station according to LTE. The NG RAN 30 includes a gNB 100B, which is a radio base station according to 5G (NR). The NG RAN 30 may be connected to a User Plane Function (hereinafter, UPF), which is included in the 5G system architecture and provides user plane functionality. The E-UTRAN 20 and NG RAN 30 (which may be eNB 100A or gNB 100B) may be referred to simply as a network.

The eNB 100A, the gNB 100B, and the UE 200 may support carrier aggregation (CA) using a plurality of component carriers (CCs), and dual connectivity for simultaneously transmitting component carriers between a plurality of NG-RAN Nodes and UE, and the like.

The eNB 100A, the gNB 100B, and the UE 200 perform radio communication via a radio bearer, specifically, via a Signalling Radio Bearer (SRB) or a DRB Data Radio Bearer (DRB).

In the present embodiment, Multi-Radio Dual Connectivity (MR-DC) in which the eNB 100A constitutes a master node (MN) and the gNB 100B constitutes a secondary node (SN), specifically, E-UTRA-NR Dual Connectivity (EN-DC) may be performed. Alternatively, NR-E-UTRA Dual Connectivity (NE-DC) in which the gNB 100B constitutes an MN) and the eNB 100A constitutes an SN may be performed. Alternatively, NR-NR Dual Connectivity (NR-DC) in which the gNB constitutes a MN and an SN may be performed.

Thus, the UE 200 supports dual connectivity that is connected to the eNB 100A and the gNB 100B.

The eNB 100A is included in a master cell group (MCG), and the gNB 100B is included in a secondary cell group (SCG). That is, the gNB 100B is an SN included in the SCG.

The eNB 100A and the gNB 100B may be referred to as a radio base station or a network device.

The UE 200 can perform transition between cells formed by the eNB 100A and the gNB 100B. “Transition” typically means a handover between cells, but can also include a behavior of the UE 200 which changes the cell to which the UE 200 is connected, such as a cell reselection.

In particular, in the present embodiment, a conditional handover (CHO) may be supported in the radio communication system 10. The CHO may be interpreted as a handover procedure that is performed only when an execution condition is met.

The CHO may be defined as a handover performed by the UE 200 when one or more handover execution conditions are met. The UE 200 may start evaluating an execution condition upon receipt of a CHO configuration, and may stop evaluating an execution condition when a handover (a legacy handover or a conditional handover) is performed.

The CHO configuration includes a CHO candidate cell configuration generated by a candidate cell (candidate gNB), and an execution condition generated by a source cell (gNB) which is a handover source.

The execution condition may include one or two trigger conditions (CHO events A3/A5 specified in 3GPP TS 38.331). A single reference signal (RS) type may be triggered, and up to two different trigger quantities (for example, Reference Signal Received Power (RSRP) and Reference Signal Received Quality (RSRQ), RSRP and Signal-to-Interference plus Noise power Ratio (SINR), or the like) may be configured simultaneously so as to evaluate a CHO execution condition of a single candidate cell.

When the UE 200 receives an HO instruction (which may be called an HO command) (without a CHO configuration) before the CHO execution condition is met, the UE 200 may perform an HO procedure (see 3GPP TS38.300, Chapter 9.2.3.2) regardless of the CHO configuration that is previously received.

The radio communication system 10 may also support a conditional addition or a change of a Primary SCell (PSCell) (conditional PSCell addition/change). A PSCell is a type of secondary cell. A PSCell may mean a primary SCell (a secondary cell), and it may be interpreted that any one of several SCells corresponds to a PSCell.

The secondary cell may be read as meaning a secondary node (SN), or a secondary cell group (SCG). The conditional PSCell addition/change makes it possible to realize an addition or a change of the secondary cell efficiently and quickly.

The conditional PSCell addition/change may be interpreted as a procedure for an addition/change of a conditional secondary cell (a secondary node) in which the procedure is simplified. The conditional PSCell addition/change may mean at least one of addition or change of an SCell.

The radio communication system 10 may also support a procedure for a conditional PSCell change between SNs. Specifically, the radio communication system 10 may support MN-initiated conditional PSCell change and/or SN-initiated conditional PSCell change.

### (2) Functional Block Configuration of Radio Communication System

Next, a functional block configuration of the radio communication system 10 will be described. Specifically, the functional block configuration of the eNB 100A, the gNB 100B, and the UE 200 will be described.

### (2.1) eNB 100A and gNB 100B

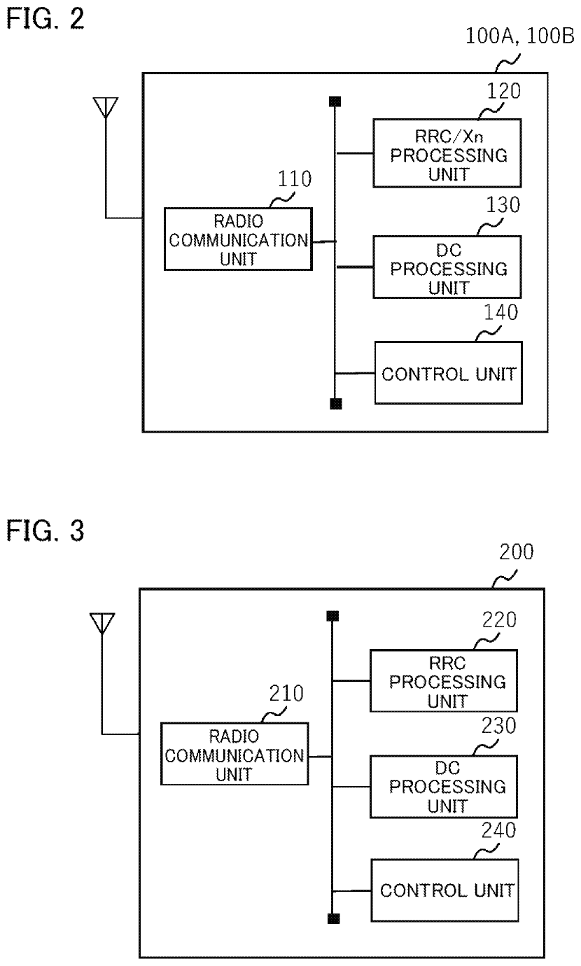

FIG. 2 is a functional block diagram of the eNB 100A and the gNB 100B. As illustrated in FIG. 2, the eNB 100A and the gNB 100B include a radio communication unit 110, an RRC/Xn processing unit 120, a DC processing unit 130, and a control unit 140.

The radio communication unit 110 transmits a downlink signal (DL signal) according to LTE. In addition, the radio communication unit 110 receives an uplink signal (UL signal) according to LTE.

The RRC/Xn processing unit 120 performs various processing relating to a radio resource control layer (RRC) and an Xn interface. Specifically, the RRC/Xn processing unit 120 can transmit an RRC Reconfiguration to the UE 200. In addition, the RRC/Xn processing unit 120 can receive an RRC Reconfiguration Complete, which is a response to the RRC Reconfiguration, from the UE 200.

In the present embodiment, the eNB 100A supports LTE. In this case, the name of an RRC message may be an RRC Connection Reconfiguration, or an RRC Connection Reconfiguration Complete.

In the case where a radio base station supports LTE (Evolved Universal Terrestrial Radio Access Network (E-UTRAN)), an X2 interface may be used instead of an Xn interface. Alternatively, the Xn and X2 interfaces may be used together. The Xn interface will be described below as an example.

The RRC/Xn processing unit 120 can transmit and receive inter-node messages via the Xn interface. For example, when constituting the secondary node (SN), the RRC/Xn processing unit 120 may receive a message relating to an SCell (which may include a PSCell; hereinafter, the same shall apply) from another radio base station, specifically, from the master node (MN).

Meanwhile, when constituting the MN, the RRC/Xn processing unit 120 may receive a message relating to an addition/change of the SCell from another radio base station, specifically, from the SN. The RRC/Xn processing unit 120 may receive a message relating to an addition of the SCell, and a message relating to a change of the SCell.

More specifically, the RRC/Xn processing unit 120 may receive SN change required and/or an SN Addition Request Ack from the SN.

The DC processing unit 130 performs processing relating to dual connectivity, specifically, Multi-RAT Dual Connectivity (MR-DC). In the present embodiment, since the eNB 100A supports LTE and the gNB 100B supports NR, the DC processing unit 130 may perform processing relating to E-UTRA-NR Dual Connectivity (EN-DC). Note that, as described above, the type of DC is not limited, and the DC processing unit 130 may support, for example, NR-E-UTRA Dual Connectivity (NE-DC), or NR-NR Dual Connectivity (NR-DC).

The DC processing unit 130 can transmit and receive messages specified in 3GPP TS37.340 or the like, and perform processing for configuring and releasing DC between the eNB 100A, the gNB 100B, and the UE 200.

The control unit 140 controls each function block constituting the eNB 100A. In particular, in the present embodiment, the control unit 140 performs control relating to a conditional handover (CHO), and an addition or a change of a secondary node.

Specifically, the control unit 140 performs control relating to a normal handover of the UE 200 (which may be called a legacy handover), and a conditional handover (CHO) of the UE 200.

The control unit 140 controls an execution of a procedure for an addition/change of an SCell, in particular, an execution of the conditional PSCell addition/change. Specifically, the control unit 140 can perform an addition or a change of the SCell based on an execution condition by cooperating with the SN (or the MN).

In the present embodiment, a channel includes a control channel and a data channel. The control channel includes a PDCCH (Physical Downlink Control Channel), a PUCCH (Physical Uplink Control Channel), a PRACH (Physical Random Access Channel), a PBCH (Physical Broadcast Channel), and the like.

The data channel includes a PDSCH (Physical Downlink Shared Channel), a PUSCH (Physical Uplink Shared Channel), and the like.

A reference signal includes a Demodulation Reference Signal (DMRS), a Sounding Reference Signal (SRS), a Phase Tracking Reference (PTRS), Signal a Channel State Information-Reference Signal (CSI-RS), and the like. A signal includes a channel and a reference signal. Further, data may mean data transmitted via a data channel.

### (2.2) UE 200

FIG. 3 is a functional block diagram of the UE 200. As illustrated in FIG. 3, the UE 200 includes a radio communication unit 210, an RRC processing unit 220, a DC processing unit 230, and a control unit 240.

The radio communication unit 210 transmits an uplink signal (UL signal) according to LTE or NR. In addition, the radio communication unit 210 receives a downlink signal (DL signal) according to LTE. In other words, the UE 200 can access the eNB 100A (E-UTRAN 20) and the gNB 100B (NG RAN 30), and can support dual connectivity (specifically, EN-DC).

The RRC processing unit 220 performs various processing in the radio resource control layer (RRC). Specifically, the RRC processing unit 220 can transmit and receive a radio resource control layer message. In the present embodiment, the RRC processing unit 220 constitutes a transmission unit.

The RRC processing unit 220 can receive an RRC Reconfiguration from the network, specifically, from the E-UTRAN 20 (or NG RAN 30). In addition, the RRC processing unit 220 can transmit an RRC Reconfiguration Complete, which is a response to the RRC Reconfiguration, to the network.

The DC processing unit 230 performs processing relating to dual connectivity, specifically, MR-DC. As described above, in the present embodiment, the DC processing unit 230 may perform processing relating to EN-DC; however, the DC processing unit 230 may perform processing relating to NE-DC and/or NR-DC.

The DC processing unit 230 can access each of the eNB 100A and the gNB 100B, and perform a configuration in a plurality of layers (a media access control layer (MAC), a radio link control layer (RLC), a packet data convergence protocol layer (PDCP), and the like) including the RRC.

The control unit 240 controls each function block constituting the UE 200. In particular, in the present embodiment, the control unit 240 controls an execution of a conditional handover (CHO) and a conditional PSCell addition/change (CPAC).

Specifically, when CHO and CPAC are configured simultaneously, or an execution condition of CHO and an execution condition of CPAC are met simultaneously, the control unit 240 may prioritize either CHO or CPAC according to a state of an RRC layer message.

The control unit 240 may preferentially perform a CHO procedure when an execution condition of CHO is met before transmitting a specific RRC layer message, for example, an RRC Reconfiguration Complete, to the source MN (which may be called a transition source radio base station, or the like). In this case, the control unit 240 may discard a CPAC configuration.

Alternatively, the control unit 240 may perform a CPAC procedure if an execution condition of CHO is not met before transmitting an RRC Reconfiguration Complete to the source MN. Thereafter, the control unit 240 may perform a CHO procedure if the execution condition of CHO is met.

The control unit 240 may also determine the contents of the report on a radio link failure (RLF) and/or a handover according to an execution of CHO or CPAC.

Specifically, the control unit 240 may change the contents of an RLF report or a successful handover report according to an execution of either CHO or CPAC. The content may include, for example, identification information (for example, an NR Physical Cell ID (PCI), an NR Cell Global Identifier (CGI)) of a candidate cell (PSCell), the time from when an execution condition is configured until the execution condition is met, the time from when an execution condition is configured until a CPAC configuration is discarded, the time from a CHO execution condition is met to the success of CHO, and the like.

Further, the content may include identification information of a source PCell (PCell ID), identification information of a target PCell/PSCell, cell quality, a CHO configuration, candidate cell information, and the like. The content may also be stored as a VarRLF-Report, or the like. The content may also be transmitted to a target MN as SCG failure information. The details of the RLF report and successful handover report will be described later.

### (3) Operation of Radio Communication System

Next, an operation of the radio communication system 10 will be described. Specifically, an operation example of the UE 200 and a network when CHO and CPAC are configured simultaneously will be described.

### (3.1) Operation Example 1

A description will be given regarding an operation when both an execution condition of CHO and an execution condition of CPAC are met simultaneously.

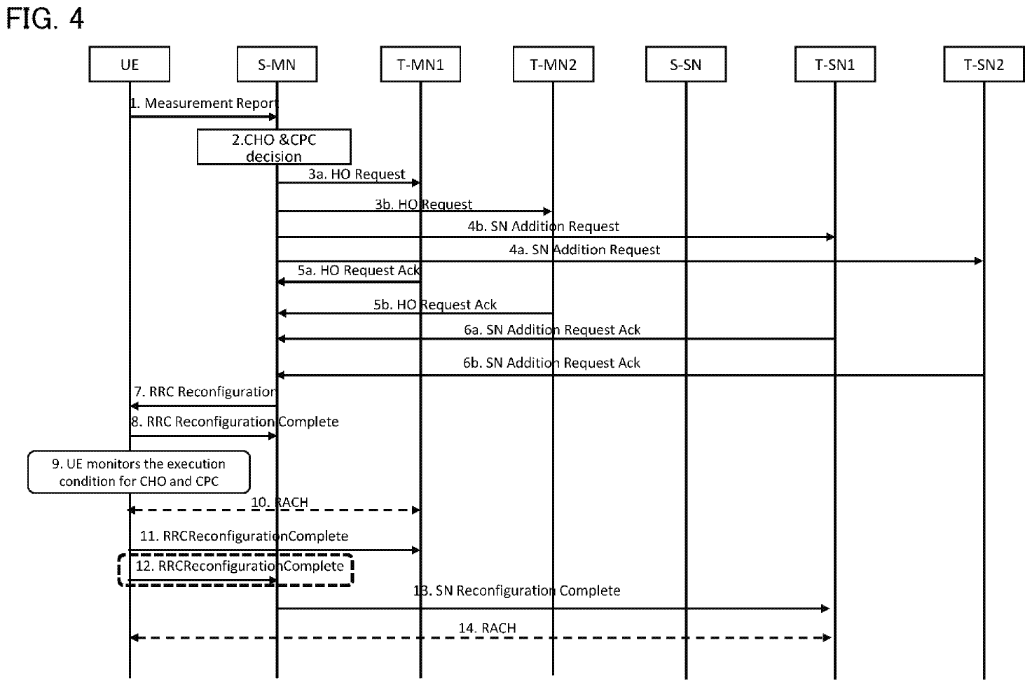

FIG. 4 illustrates an example of a conventional sequence relating to a change of a PSCell when CHO and CPAC are configured. As illustrated in FIG. 4, the source MN (S-MN) determines that CHO and CPC (conditional PSCell change, in which CPA (conditional PSCell addition) may also be possible) can be performed (step 2), and performs a procedure for an addition of SN (step 3a and thereafter).

Here, if CHO is performed first, there is a possibility that the S-MN may have been released, and thus the UE 200 cannot transmit an RRC Reconfiguration Complete (an RRC Reconfiguration response to T (Target)-SN1) to the S-MN. That is, there is a problem that the UE 200 cannot transmit an SN Reconfiguration Complete to the T-SN via the S-MN (see the dotted box in the figure).

If CHO and CPAC are configured simultaneously, there is a possibility that the UE 200 may release the S-MN and access the target MN if an execution condition of CHO is met before CPAC, or if an execution condition of CHO and an execution condition of CPAC are met simultaneously. For this reason, if the execution condition of CPAC is met after releasing the S-MN, the UE 200 cannot transmit an RRC Reconfiguration Complete to the S-MN.

Accordingly, the UE 200 and the network may operate as follows:

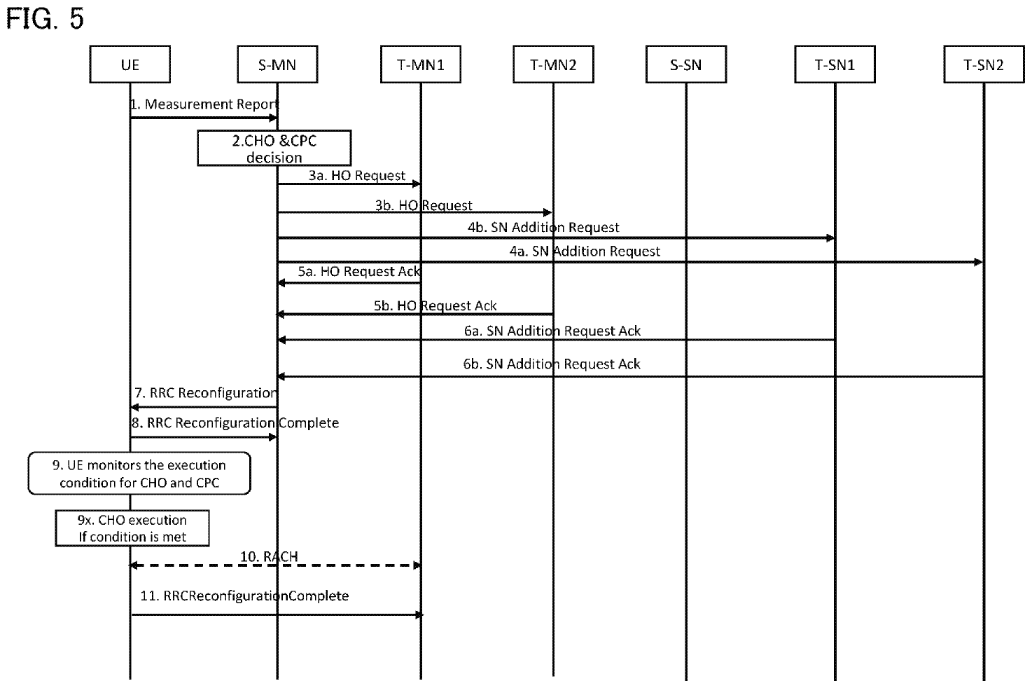

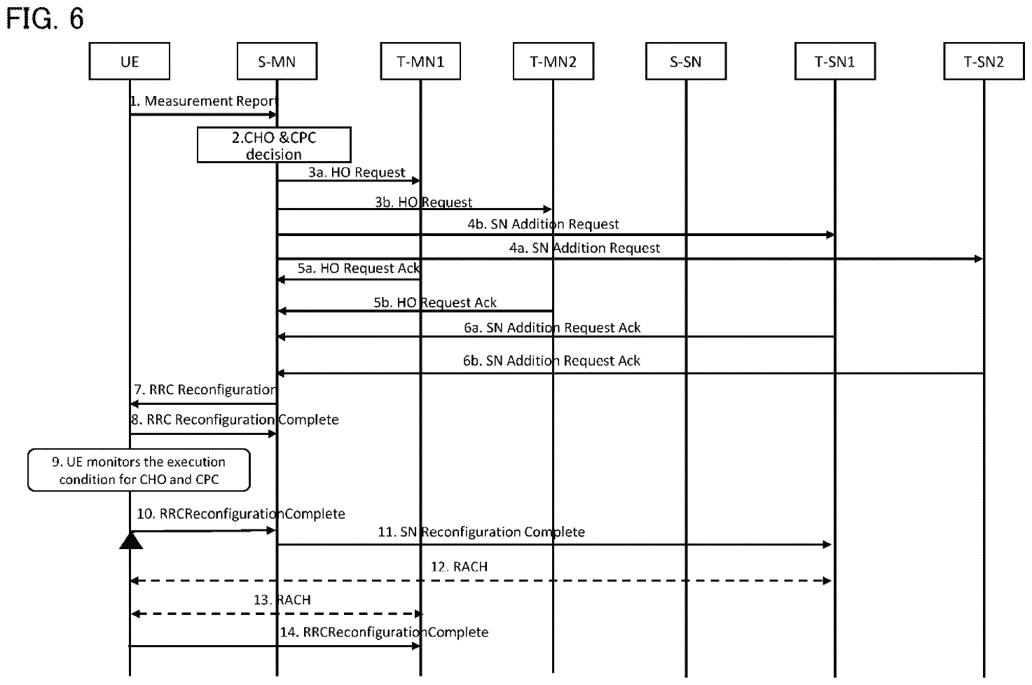

FIG. 5 illustrates an example of a sequence (part 1) relating to a change of a PSCell when CHO and CPAC are configured. FIG. 6 illustrates an example of a sequence (part 2) relating to a change of a PSCell when CHO and CPAC are configured.

For example, as illustrated in FIG. 5, the UE 200 may perform a CHO procedure preferentially if CHO and CPAC are configured simultaneously and an execution condition of CHO and an execution condition of CPAC are simultaneously met (step 9x). In this case, the UE 200 may discard a CPAC configuration.

Alternatively, the UE 200 may perform a CHO procedure preferentially and discard a CPAC configuration if CHO and CPAC are configured simultaneously and an execution condition of CHO is met first.

Alternatively, the UE 200 may operate according to any of the cases described below if CHO and CPAC are configured simultaneously and an execution condition of CPAC is met first.
As illustrated in FIG. 6, the UE 200 may perform a CHO procedure preferentially if an execution condition of CHO is met before transmitting an RRC Reconfiguration Complete to the S-MN (triangle mark in step 10). The UE 200 may discard a CPAC configuration.
The UE 200 may perform a CPAC procedure if an execution condition of CHO is not met before transmitting an RRC Reconfiguration Complete to the S-MN (triangle mark in step 10). Thereafter, if an execution condition of the CHO is met, the UE 200 may perform the CHO procedure.

### (3.2) Operation Example 2

In the present example, a description will be given regarding an operation relating to an RLF report and a successful handover report when CHO and CPAC are configured simultaneously.

Specifically, in the present example, the UE 200 may change the contents of an RLF report and a successful handover report which are to be transmitted to the network according to the following cases in which CHO and CPAC are configured simultaneously.

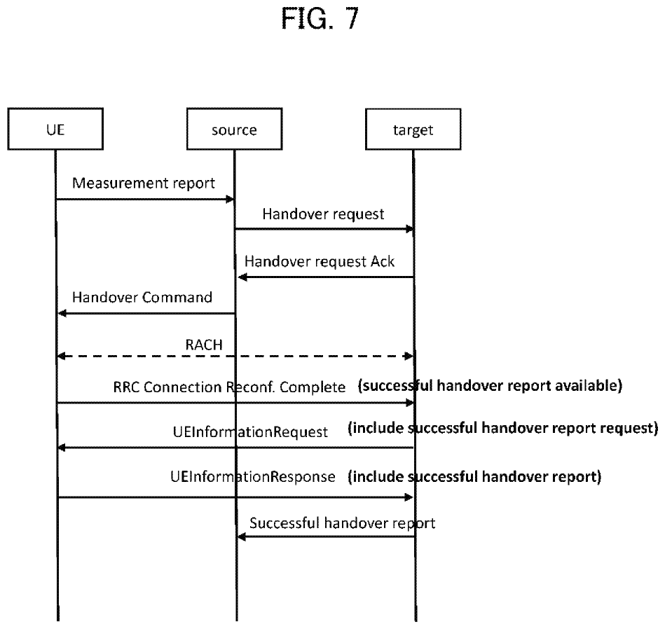

FIG. 7 illustrates an example of a sequence relating to a successful handover report. Although the sequence illustrated in FIG. 7 assumes CPAC, the same sequence may be applied to CHO.

### (3.2.1) Case 1

This case is when CHO is performed preferentially and a CPAC configuration is discarded.

### (3.2.1.1) If CHO Has Succeeded

The UE 200 may report the following contents to the network, as an RLF report or a successful handover report.
Discarded CPAC configuration (execution condition and candidate PSCell ID (PCI, CGI, or condReconfigurationId) and the configuration).
Time from when CHO execution condition is configured until condition is met (HO execution).
Time from when CPAC execution condition is configured until CPAC configuration is discarded.
Time from when CHO execution condition is met to the success of CHO

These contents may be stored in the UE 200 as a VarRLF-Report. In addition, the UE 200 may report these contents to the target MN (T-MN), as SCG failure information. Alternatively, the UE 200 may store these contents in a successful handover report, and report the successful handover report to the T-MN.

### (3.2.1.2) If CHO Has Failed

The UE 200 may report the following contents to the network, as an RLF report.
Source PCell ID
Failed target PCell ID and the cell quality
Configuration of CHO execution condition
Candidate cell information (cell ID, cell quality, and whether execution condition is met).
Time from when CHO execution condition is configured until condition is met (HO execution)
Time from when CPAC execution condition is configured until CPAC configuration is discarded.
Discarded CPAC configuration (execution condition and candidate PSCell (PCI, CGI, or condReconfigurationId) and the configuration).
Time from when CHO execution condition is met to the failure of CHO
Discarded CPAC configuration

These contents may be stored in the UE 200 as a VarRLF-Report. In addition, the UE 200 may report these contents to the T-MN. The T-MN may transmit these contents to the S-MN, as a Failure Indication message.

### (3.2.2) Case 2

This case is when both CPAC and CHO are performed. This case is further divided into the following three cases.

### (3.2.2.1) If CPAC Has Failed and CHO Has Succeeded

The UE 200 may report the following contents to the network, as an RLF report or a successful handover report.
Source PSCell ID.
Failed target PSCell and the cell quality
Configuration of CPAC execution condition
Candidate cell information (PScell ID, cell quality, and whether execution condition is met).
If CHO has failed the first time and has succeeded the second time (when CHO configuration is directly applied in a case where a reselected cell is a CHO candidate cell), the following contents may be reported.
   PCell ID that has failed the first time, and PCell ID that has succeeded the second time.
If CHO has failed the first time, and CPAC configuration is discarded if CHO has succeeded the second time, the following contents may be reported.
   Discarded CPAC configuration (execution condition and candidate PSCell ID (PCI, CGI, or condReconfigurationId) and the configuration).
Time from when CHO execution condition and CPAC execution condition are configured until the conditions are met.
Time from when CHO execution condition is met to the success of CHO.
Time from CPAC execution condition is met to the failure of CPAC

These contents may be stored in the UE 200 as a VarRLF-Report. In addition, the UE 200 may report these contents to the T-MN, as SCG failure information. The failure information may be transferred from the T-MN to the S-MN. Alternatively, the UE 200 may include the failure information in a successful handover report, and report the successful handover report to the T-MN.

### (3.2.2.2) If CPAC Has Succeeded and CHO Has Failed

The UE 200 may report the following contents to the network, as an RLF report or a successful handover report.
Source PCell ID
Failed target PCell ID and the cell quality
Configuration of CHO execution condition
Candidate cell information (cell ID, cell quality, and whether execution condition is met).
If the CHO has failed the first time and also failed the second time (when CHO configuration is directly applied in a case where a reselected cell is a CHO candidate cell), the following contents may be reported.
   PCell ID that has failed the first time, and PCell ID that has failed the second time.
   Time from when CHO execution condition and CPAC condition are configured until the conditions are met.
   Time from when CHO execution condition is met to the failure of CHO
   Time from CPAC execution condition is met to the success of CPAC

These contents may be stored in the UE 200 as a VarRLF-Report. In addition, the UE 200 may report the failure information to the reconnected PCell. The failure information may be transferred from the node forming the reconnected PCell to the S-MN.

Alternatively, the RLF information may be reported to the T-SN as MCGFailureInfo, if SRB3, which is a radio bearer for specific RRC messages in the MR-DC state, is configured.

Further, the T-SN may notify the S-MN/T-MN of the RLF information, and the MN may perform MCG recovery by transmitting the RRC Reconfiguration to the SN.

### (3.2.2.3) If Both CPAC and CHO Has Failed

The UE 200 may report the following contents to the network, as an RLF report or a successful handover report.
Source PCell ID/PSCell ID, and failed target PCell ID/PSCell ID
Configuration of CHO/CPAC execution condition
Candidate PCell/PSCell information (PCell/PSCell ID, cell quality, and whether execution condition is met).
If the CHO has failed the first time and also failed the second time (when CHO configuration is directly applied in a case where a reselected cell is a CHO candidate cell), the following contents may be reported.
   PCell ID that has failed the first time, and PCell ID that has failed the second time.
If CHO has failed the first and CPAC configuration is discarded if CHO has also failed the second time, the following contents may be reported.
   Discarded CPAC configuration (execution condition and candidate PSCell ID (PCI, CGI, or condReconfigurationId) and the configuration).
   Time from when CHO execution condition and CPAC execution condition are configured until the conditions are met.
   Time from when CHO/CPAC execution condition is met to the failure of CHO and CPAC

These contents may be stored in the UE 200 as a VarRLF-Report. In addition, the UE 200 may report the RLF information to the reconnected PCell. The failure information may be transferred from the node forming the reconnected PCell to the S-MN.

### (4) Operation and Effect

According to the above-described embodiment, the following operation and effect can be obtained. Specifically, even when CHO and CPAC are configured simultaneously, the UE 200 can reliably determine the condition under which CHO is preferentially performed, and the condition under which both CHO and CPAC can be performed. This makes it possible to realize the coexistence of CHO and CPAC.

In addition, the failure information of CHO and/or CPAC can be reported to the network as an RLF report or a successful handover report, which can help to optimize the configuration of CHO and CPAC.

### (5) Other Embodiments

Although the present invention have been described along with the examples, the present invention is not limited to the description of the embodiment, and it is obvious to those skilled in the art that various modifications and improvements are possible.

For example, in the embodiment described above, a description has been given regarding EN-DC in which an MN is an eNB and an SN is a gNB as an example; however, as described above, other DCs may be used. Specifically, NR-DC in which an MN is a gNB and an SN is a gNB, or NE-DC in which an MN is a gNB and an SN is an eNB may be used.

In the above-described embodiment, CPC has been mainly described as an example; however, the above-described operation example may be applied to CPA, or Conditional SCG change.

In the above description, configure, activate, update, indicate, enable, specify, and select may be interchangeably interpreted. Similarly, link, associate, correspond, and map may be interchangeably interpreted, and allocate, assign, monitor, and map may also be interchangeably interpreted.

In addition, specific, dedicated, UE-specific, and UE-dedicated may be interchangeably interpreted. Similarly, common, shared, group-common, UE-common, and UE-shared may be interchangeably interpreted.

The block diagram (FIGS. 2 and 3) used in the description of the above-described embodiment illustrates blocks in units of functions. Those functional blocks (components) can be realized by any combination of at least one of hardware and software. A realization method for each functional block is not particularly limited. That is, each functional block may be realized by using one device combined physically or logically. Alternatively, two or more devices separated physically or logically may be directly or indirectly connected (for example, wired, or radio) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that makes a transmitting function work may be called a transmitting unit or a transmitter. For any of the above, as described above, the realization method is not particularly limited.

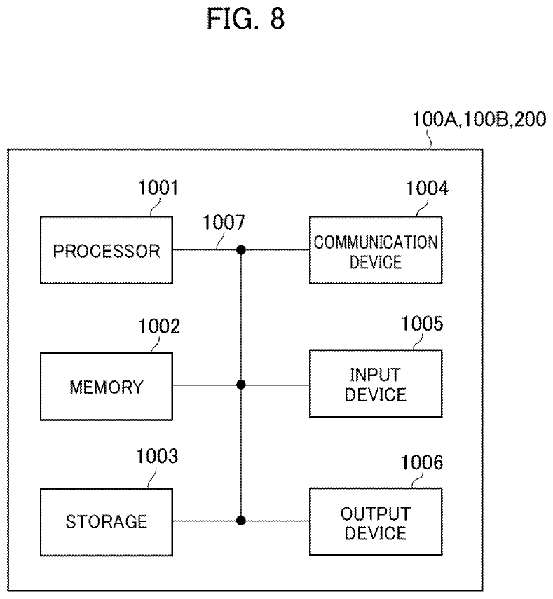

Further, the above-described eNB 100A, gNB 100B, and UE 200 (the device) may function as a computer that performs processing of a radio communication method of the present disclosure. FIG. 8 is a diagram illustrating an example of a hardware configuration of the device. As illustrated in FIG. 8, the device may be configured as a computer device including a processor 1001, a memory 1002, a storage 1003, a communication device 1004, an input device 1005, an output device 1006, a bus 1007, and the like.

Furthermore, in the following description, the term “device” can be read as meaning circuit, unit, or the like. The hardware configuration of the device may include one or more devices illustrated in the figure or may not include some of the devices.

Each of the functional blocks of the device (FIGS. 2 and 3) is implemented by means of any of hardware elements of the computer device or a combination of the hardware elements.

Each function in the device is realized by loading predetermined software (programs) on hardware such as the processor 1001 and the memory 1002 so that the processor 1001 performs arithmetic operations to control communication via the communication device 1004 and to control at least one of reading and writing of data on the memory 1002 and the storage 1003.

The processor 1001 operates, for example, an operating system to control the entire computer. The processor 1001 may be configured with a central processing unit (CPU) including interfaces with peripheral devices, control devices, arithmetic devices, registers, and the like.

Moreover, the processor 1001 reads a program (program code), a software module, data, and the like from at least one of the storage 1003 and the communication device 1004 into the memory 1002, and performs various processes according to these. As the program, a program causing the computer to perform at least part of the operation described in the above embodiment is used. Alternatively, various processes described above may be performed by one processor 1001 or may be performed simultaneously or sequentially by two or more processors 1001. The processor 1001 may be implemented by using one or more chips. Alternatively, the program may be transmitted from a network via a telecommunication line.

The memory 1002 is a computer readable recording medium and may be configured, for example, with at least one of a Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), and the like. The memory 1002 may store therein programs (program codes), software modules, and the like that can perform the method according to one embodiment of the present disclosure.

The storage 1003 is a computer readable recording medium. Examples of the storage 1003 include at least one of an optical disk such as Compact Disc ROM (CD-ROM), a hard disk drive, a flexible disk, a magneto-optical disk (for example, a compact disk, a digital versatile disk, Blu-ray (registered trademark) disk), a smart card, a flash memory (for example, a card, a stick, a key drive), a floppy (registered trademark) disk, a magnetic strip, and the like. The storage 1003 may be referred to as an auxiliary storage device. The recording medium may be, for example, a database including at least one of the memory 1002 and the storage 1003, a server, or other appropriate medium.

The communication device 1004 is hardware (transmission/reception device) capable of performing communication between computers via at least one of a wired network and a radio network. The communication device 1004 is also referred to as, for example, a network device, a network controller, a network card, a communication module, and the like.

The communication device 1004 may include a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may have an integrated configuration (for example, a touch screen).

Also, the respective devices such as the processor 1001 and the memory 1002 are connected to each other with the bus 1007 for communicating information. The bus 1007 may be constituted by a single bus or may be constituted by different buses for each device-to-device.

Further, the device may be configured to include hardware such as a microprocessor, a Digital Signal Processor (DSP), an Application Specific Integrated Circuit (ASIC), a Programmable Logic Device (PLD), and a Field Programmable Gate Array (FPGA). Some or all of these functional blocks may be realized by means of this hardware. For example, the processor 1001 may be implemented by using at least one of the above-described items of hardware.

Further, notification of information is not limited to that in the aspect/embodiment described in the present disclosure, and may be performed by using other methods. For example, notification of information may be performed by physical layer signaling (for example, Downlink Control Information (DCI), Uplink Control Information (UCI), higher layer signaling (for example, RRC signaling, Medium Access Control (MAC) signaling), broadcast information (Master Information Block (MIB), System Information Block (SIB)), other signals, or a combination thereof. The RRC signaling may also be referred to as an RRC message, for example, or may be an RRC Connection Setup message, an RRC Connection Reconfiguration message, or the like.

Each aspect/embodiment described in the present disclosure may be applied to at least one of Long Term Evolution (LTE), LTE-Advanced (LTE-A), SUPER 3G, IMT-Advanced, the 4th generation mobile communication system (4G), the 5th generation mobile communication system (5G), Future Radio Access (FRA), New Radio (NR), W-CDMA (registered trademark), GSM (registered trademark), CDMA2000, Ultra Mobile Broadband (UMB), IEEE 802. 11 (Wi-Fi (registered trademark)), IEEE 802.16 (WiMAX (registered trademark)), IEEE 802.20, ultra-wideband (UWB), Bluetooth (registered trademark), a system using any other appropriate system, and a next-generation system that is expanded based on these. Further, a plurality of systems may be combined (for example, a combination of at least one of LTE and LTE-A with 5G) and applied.

The order of the processing procedures, sequences, flowcharts, and the like of each aspect/embodiment described in the present disclosure may be exchanged as long as there is no contradiction. For example, the methods described in the present disclosure present the elements of the various steps by using an exemplary order and are not limited to the presented specific order.

The specific operation that is performed by a base station in the present disclosure may be performed by its upper node in some cases. In a network constituted by one or more network nodes having a base station, it is obvious that the various operations performed for communication with the terminal may be performed by at least one of the base station and other network nodes other than the base station (for example, an MME, an S-GW, and the like may be considered, but there is not limited thereto). In the above, an example in which there is one network node other than the base station is explained; however, a combination of a plurality of other network nodes (for example, an MME and an S-GW) may be used.

Information and signals (information and the like) can be output from a higher layer (or lower layer) to a lower layer (or higher layer). These may be input and output via a plurality of network nodes.

The input/output information may be stored in a specific location (for example, a memory) or may be managed in a management table. The information to be input/output can be overwritten, updated, or added. The information may be deleted after outputting. The inputted information may be transmitted to another device.

The determination may be made by using a value (0 or 1) represented by one bit, by truth-value (Boolean: true or false), or by comparison of numerical values (for example, comparison with a predetermined value).

Each of the aspects/embodiment described in the present disclosure may be used separately or in combination, or may be switched in accordance with the execution. In addition, notification of predetermined information (for example, notification of “is X”) is not limited to being performed explicitly, and it may be performed implicitly (for example, without notifying the predetermined information).

Regardless of being referred to as software, firmware, middleware, microcode, hardware description language, or some other name, software should be interpreted broadly to mean instructions, an instruction set, code, a code segment, program code, a program, a subprogram, a software module, an application, a software application, a software package, a routine, a subroutine, an object, an executable file, an execution thread, a procedure, a function, and the like.

Further, software, instruction, information, and the like may be transmitted and received via a transmission medium. For example, when software is transmitted from a website, a server, or another remote source by using at least one of a wired technology (a coaxial cable, an optical fiber cable, a twisted pair cable, a Digital Subscriber Line (DSL), or the like) and a radio technology (infrared light, microwave, or the like), then at least one of these wired and radio technologies is included within the definition of the transmission medium.

Information, signals, or the like described in the present invention may be represented by using any of a variety of different technologies. For example, data, an instruction, a command, information, a signal, a bit, a symbol, a chip, or the like that may be mentioned throughout the above description may be represented by a voltage, a current, an electromagnetic wave, a magnetic field or magnetic particles, an optical field or photons, or any combination thereof.

It should be noted that the terms described in the present disclosure and terms necessary for understanding the present disclosure may be replaced with terms having the same or similar meanings. For example, at least one of a channel and a symbol may be a signal (signaling). A signal may also be a message. Further, a Component Carrier (CC) may be referred to as a carrier frequency, a cell, a frequency carrier, or the like.

The terms “system” and “network” used in the present disclosure can be used interchangeably.

Furthermore, information, parameters, and the like described in the present disclosure may be represented by an absolute value, may be represented by a relative value from a predetermined value, or may be represented by corresponding other information. For example, a radio resource may be indicated using an index.

Names used for the above parameters are not restrictive names in any respect. In addition, formulas and the like using these parameters may be different from those explicitly disclosed in the present disclosure. Since the various channels (for example, a PUCCH, a PDCCH, or the like) and information elements can be identified by any suitable names, the various names allocated to these various channels and information elements shall not be restricted in any way.

In the present disclosure, the terms such as “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. A base station may also be referred to with a term such as a macro cell, a small cell, a femtocell, or a pico cell.

A base station can accommodate one or more (for example, three) cells (also referred to as sectors). In a configuration in which a base station accommodates a plurality of cells, the entire coverage area of the base station can be divided into a plurality of smaller areas. In each of the smaller areas, a communication service can be provided by a base station subsystem (for example, a small base station for indoor use (remote radio head: RRH)).

The term “cell” or “sector” refers to a part or all of the coverage area of at least one of a base station and a base station subsystem that performs a communication service in this coverage.

In the present disclosure, the terms such as “mobile station (Mobile Station: MS)”, “user terminal”, “user equipment (User Equipment: UE)”, and “terminal” can be used interchangeably.

A mobile station may be referred to as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or some other suitable terms by those skilled in the art.

At least one of a base station and a mobile station may be called a transmitting device, a receiving device, a communication device, or the like. Note that at least one of a base station and a mobile station may be a device mounted on a moving body, a moving body itself, or the like. The moving body may be a vehicle (for example, a car, an airplane, or the like), an unmanned moving body (a drone, a self-driving car, or the like), or a robot (manned type or unmanned type). At least one of a base station and a mobile station also includes a device that does not necessarily move during the communication operation. For example, at least one of a base station and a mobile station may be an Internet of Things (IoT) device such as a sensor.

Also, a base station in the present disclosure may be read as meaning a mobile station (user terminal, hereinafter, the same). For example, each aspect/embodiment of the present disclosure may be applied to a configuration in which communication between a base station and a mobile station is replaced with communication between a plurality of mobile stations (which may be called Device-to-Device (D2D), Vehicle-to-Everything (V2X), or the like). In this case, the mobile station may have the function of a base station. In addition, words such as “uplink” and “downlink” may also be read as meaning words corresponding to inter-terminal communication (for example, “side”). For example, an uplink channel, a downlink channel, or the like may be read as meaning a side channel.

Similarly, the mobile station in the present disclosure may be read as meaning a base station. In this case, the base station may have the function of the mobile station.

A radio frame may be composed of one or more frames in the time domain.

Each of the one or more frames in the time domain may be referred to as a subframe. A subframe may be further composed of one or more slots in the time domain.

The subframe may be a fixed time length (for example, 1 ms) independent of the numerology.

The numerology may be a communication parameter applied to at least one of transmission and reception of a certain signal or channel. The numerology may indicate at least one of, for example, subcarrier spacing (SCS), bandwidth, symbol length, cyclic prefix length, transmission time interval (TTI), the number of symbols per TTI, radio frame configuration, a specific filtering process performed by a transceiver in the frequency domain, a specific windowing process performed by a transceiver in the time domain, and the like.

A slot may be composed of one or more symbols (Orthogonal Frequency Division Multiplexing (OFDM)) symbols, Single Carrier Frequency Division Multiple Access (SC-FDMA) symbols, and the like) in the time domain. A slot may be a unit of time based on the numerology.

A slot may include a plurality of minislots. Each minislot may be composed of one or more symbols in the time domain. A minislot may be called a subslot. A minislot may be composed of fewer symbols than slots. A PDSCH (or PUSCH) transmitted in time units greater than the minislot may be referred to as a PDSCH (or PUSCH) mapping type A. A PDSCH (or PUSCH) transmitted using a minislot may be referred to as a PDSCH (or PUSCH) mapping type B.

Each of a radio frame, subframe, slot, minislot, and symbol represents a time unit for transmitting a signal. A radio frame, subframe, slot, minislot, and symbol may have respectively different names corresponding to them.

For example, one subframe may be called a transmission time interval (TTI), a plurality of consecutive subframes may be called a TTI, and one slot or one minislot may be called a TTI. That is, at least one of the subframe and TTI may be a subframe (1 ms) in the existing LTE, a period shorter than 1 ms (for example, 1 to 13 symbols), or a period longer than 1 ms. Note that, a unit representing TTI may be called a slot, a minislot, or the like instead of a subframe.

Here, a TTI refers to the minimum time unit of scheduling in radio communication, for example. For example, in the LTE system, the base station performs scheduling for allocating radio resources (frequency bandwidth, transmission power, and the like that can be used in each user terminal) to each user terminal in units of TTI. The definition of TTI is not limited to this.

A TTI may be a transmission time unit such as a channel-coded data packet (transport block), a code block, or a code word, or may be a processing unit such as scheduling or link adaptation. When a TTI is given, a time interval (for example, the number of symbols) in which a transport block, a code block, a code word, and the like are actually mapped may be shorter than TTI.

When one slot or one minislot is called a TTI, one or more TTIS (that is, one or more slots or one or more minislots) may be the minimum time unit of the scheduling. The number of slots (minislot number) constituting the minimum time unit of the scheduling may be controlled.

A TTI having a time length of 1 ms may be referred to as an ordinary TTI (TTI in LTE Rel. 8-12), a normal TTI, a long TTI, an ordinary subframe, a normal subframe, a long subframe, a slot, and the like. A TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, and the like) may be read as meaning a TTI having a time length exceeding 1 ms, and a short TTI (for example, shortened TTI) may be read as meaning a TTI having a TTI length of less than a TTI length of a long TTI and a TTI length of 1 ms or more.

A resource block (RB) is a resource allocation unit in the time domain and the frequency domain, and may include one or more consecutive subcarriers in the frequency domain.

The number of subcarriers included in the RB may be the same regardless of the numerology, and may be 12, for example. The number of subcarriers included in the RB may be determined based on the numerology.

Further, the time domain of an RB may include one or more symbols, and may have a length of 1 slot, 1 minislot, 1 subframe, or 1 TTI. Each TTI, subframe, or the like may be composed of one or more resource blocks.

Note that, one or more RBs may be called a physical resource block (PRB), a subcarrier group (SCG), a resource element group (REG), a PRB pair, a RB pair, and the like.

A resource block may be configured by one or more resource elements (REs). For example, one RE may be a radio resource domain of one subcarrier and one symbol.

A bandwidth part (BWP) (which may be called a partial bandwidth or the like) may represent a subset of consecutive common resource blocks (RBs) for a certain numerology in a certain carrier. Here, the common RB may be specified by an index of the RB based on the common reference point of the carrier. A PRB may be defined in a certain BWP and numbered within that BWP.

A BWP may include a BWP for UL (UL BWP) and a BWP for DL (DL BWP). One or more BWPs may be configured in one carrier for the UE.

At least one of the configured BWPs may be active, and the UE does not have to expect to transmit and receive predetermined signals/channels outside the active BWP. Note that “cell”, “carrier”, and the like in this disclosure may be read as meaning “BWP”.

The above-described structures such as a radio frame, a subframe, a slot, a minislot, and a symbol are merely examples. For example, structures such as the number of subframes included in a radio frame, the number of slots per subframe or radio frame, the number of minislots included in a slot, the number of symbols and RBs included in a slot or minislot, the number of subcarriers included in RBs, and the number of symbols included in a TTI, a symbol length, the cyclic prefix (CP) length, and the like can be changed in various manner.

The terms “connected”, “coupled”, or any variations thereof mean any direct or indirect connection or coupling between two or more elements, and can include that one or more intermediate elements are present between two elements that are “connected” or “coupled” to each other. The coupling or connection between the elements may be physical, logical, or a combination thereof. For example, “connection” may be read as meaning “access”. In the present disclosure, two elements can be “connected” or “coupled” to each other by using at least one of one or more wires, one or more cables, and one or more printed electrical connections, and as some non-limiting and non-exhaustive examples, by using electromagnetic energy having wavelengths in the radio frequency domain, a microwave region, and a light (both visible and invisible) region, and the like.

A reference signal may be abbreviated as RS and may be called a pilot according to applicable standards.

As used in the present disclosure, the phrase “based on” does not mean “based only on” unless explicitly stated otherwise. In other words, the phrase “based on” means both “based only on” and “based at least on”.

“Means” in the configuration of each device above may be replaced with “unit”, “circuit”, “device”, and the like.

Any reference to elements using a designation such as “first”, “second”, or the like used in the present disclosure generally does not limit the amount or order of those elements. Such designations can be used in the present disclosure as a convenient method to distinguish between two or more elements. Thus, the reference to the first and second elements does not imply that only two elements can be adopted, or that the first element has to precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive-OR.

Throughout the present disclosure, for example, during translation, if articles such as a, an, and the in English are added, the present disclosure may include that a noun following these articles is used in plural.

As used in this disclosure, the term “determining” may encompass a wide variety of actions. “determining” includes deeming that determining has been performed by, for example, judging, calculating, computing, processing, deriving, investigating, searching (looking up, search, inquiry) (for example, searching in a table, database, or another data structure), ascertaining, and the like. In addition, “determining” can include deeming that determining has been performed by receiving (for example, receiving information), transmitting (for example, transmitting information), inputting (input), outputting (output), access (accessing) (for example, accessing data in a memory), and the like. In addition, “determining” can include deeming that determining has been performed by resolving, selecting, choosing, establishing, comparing, and the like. That is, “determining” may include deeming that “determining” regarding some action has been performed. Moreover, “determining” may be read as meaning “assuming”, “expecting”, “considering”, and the like.

In the present disclosure, the wording “A and B are different” may mean “A and B are different from each other”. It should be noted that the wording may mean “A and B are each different from C”. Terms such as “separate”, “couple”, or the like may also be interpreted in the same manner as “different”.

Although the present disclosure has been described in detail above, it will be obvious to those skilled in the art that the present disclosure is not limited to the embodiments described in the present disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### Reference Signs List

10: radio communication system
20: E-UTRAN
30: NG RAN
100A: eNB
100B: gNB
110: radio communication unit
120: RRC/Xn processing unit
130: DC processing unit
140: control unit
200: UE
210: radio communication unit
220: RRC processing unit
230: DC processing unit
240: control unit
1001: processor
1002: memory
1003: storage
1004: communication device
1005: input device
1006: output device
1007: bus

1. A terminal comprising:
a control unit that controls an execution of a conditional handover and an execution of a procedure for an addition/change of a secondary cell; and
a transmission unit that transmits a radio resource control layer message, wherein
when the conditional handover and the procedure for the addition/change are configured simultaneously, or when an execution condition of the conditional handover and an execution condition of the procedure for the addition/change are met simultaneously, the control unit prioritizes either the conditional handover or the procedure for the addition/change according to a state of the message.

2. A terminal comprising:
a control unit that controls an execution of a conditional handover and an execution of a procedure for an addition/change of a secondary cell; and
a transmission unit that transmits a report relating to at least either a radio link failure or a handover, wherein
the control unit determines contents of the report according to an execution of the conditional handover or an execution of the procedure for the addition/change.

3. A radio communication system including a terminal and a radio base station,
the terminal includes:
a control unit that controls an execution of a conditional handover and an execution of a procedure for an addition/change of a secondary cell; and
a transmission unit that transmits a radio resource control layer message, and
the radio base station includes a reception unit that receives the message, wherein
when the conditional handover and the procedure for the addition/change are configured simultaneously, or when an execution condition of the conditional handover and an execution condition of the procedure for the addition/change are met simultaneously, the control unit prioritizes either the conditional handover or the procedure for the addition/change according to a state of the message.

4. A radio communication system including a terminal and a radio base station,
the terminal includes:
a control unit that controls an execution of a conditional handover and an execution of a procedure for an addition/change of a secondary cell; and
a transmission unit that transmits a report relating to at least either a radio link failure or a handover, and
the radio base station includes a reception unit that receives the report, wherein
the control unit determines contents of the report according to an execution of the conditional handover or an execution of the procedure for the addition/change.

5. A radio communication method comprising:
a step of controlling an execution of a conditional handover and an execution of a procedure for an addition/change of a secondary cell;
a step of transmitting a radio resource control layer message; and
when the conditional handover and the procedure for the addition/change are configured simultaneously, or when an execution condition of the conditional handover and an execution condition of the procedure for the addition/change are met simultaneously, a step of prioritizing either the conditional handover or the procedure for the addition/change according to a state of the message.

6. A radio communication method comprising:
a step of controlling an execution of a conditional handover and an execution of a procedure for an addition/change of a secondary cell;
a step of transmitting a report relating to at least either a radio link failure or a handover; and
a step of determining contents of the report according to an execution of the conditional handover or an execution of the procedure for the addition/change.
